(19) United States
(12) Patent Application Publication
(10) Pub. No.: US 2026/0264159 A1
(43) Pub. Date: Sep. 10, 2026

(54) CONTROL OF INTERVAL JOINING PROCESS

(71) Applicant: Fronius International GmbH, Pettenbach (AT)

(72) Inventor: Dominik SÖLLINGER, Pettenbach (AT)

(73) Assignee: Fronius International GmbH, Pettenbach (AT)

(21) Appl. No.: 19/164,356

(22) PCT Filed: Mar. 12, 2024
(86) PCT No.: PCT/EP2024/056510

§ 371 Date: Sep. 11, 2025

(30) Foreign Application Priority Data
Mar. 13, 2023 (EP) 23161495.9

(51) Int. Cl. B23K 9/09; B23K 9/173

(52) U.S. Cl. CPC B23K 9/093; B23K 9/173

(57) ABSTRACT

In order to more accurately control the heat input that is introduced into a workpiece to be joined as part of an arc interval joining process, a first pause duration of a first pause phase is determined during the arc interval joining process and, in the event that the determined first pause duration deviates from a specified target pause duration, at least one joining parameter of the arc interval joining process, which influences the pause durations of the pause phases, is changed in order to reduce a deviation between a second pause duration of a second pause phase, which follows the first pause phase in time, and the specified target pause duration compared to the deviation of the first pause duration from the target pause duration.

The present invention relates to an arc interval joining process comprising a sequence of arc phases and pause phases, wherein the arc phases have a specified arc duration and alternate in time with the pause phases, and wherein in the arc phases a joining current flows between a joining electrode and a workpiece for joining the workpiece and in the pause phases no joining current flows. The invention further relates to a welding apparatus for carrying out an arc interval joining process, comprising a welding torch for introducing energy at a welding/brazing point on a workpiece in order to produce a molten pool, comprising a feed unit for feeding a welding wire to the molten pool, wherein the welding wire can be melted in the region of the molten pool by the energy introduced by the welding torch in order to produce a weld seam on the workpiece, and comprising a control unit for controlling the welding apparatus.

Arc interval welding and arc interval brazing are two widely used joining processes that are particularly suitable for controlling temperature distributions in joined workpieces or for controlling the heat input that is introduced into a workpiece during arc welding or arc brazing. The following explanations deal with arc interval welding and arc interval brazing, wherein the generic term “arc interval joining” is used to describe both of these joining processes.

Arc interval joining processes have arc phases and pause phases, wherein in arc phases an arc is established between a joining electrode and a workpiece (at least temporarily); in contrast, in pause phases no arc is established, so as to reduce the heat input. In an arc phase, a joining current flows, which introduces heat into a workpiece being joined; while in a pause phase, the workpiece is not subject to any heat input due to the absence of an arc, and consequently the absence of flowing joining current, and can therefore cool down and release heat.

Due to the fact that the temperature fields occurring in a workpiece during joining influence a number of quality factors, such as thermal distortion occurring in a joined workpiece or various metallurgical properties occurring in a joined workpiece, such as grain structure or seam quality, the regulation of the heat input into a workpiece being joined is of great importance, especially when welding or brazing thin sheets. According to the above, the amount of heat introduced into a workpiece during arc interval joining can be influenced by adjusting the duration of arc and pause phases, which in turn can regulate the temperature distributions occurring in a joined workpiece. Due to its direct impact on the quality factors mentioned, the possibility of regulating temperature fields is an important reason for using an arc interval joining process instead of an alternative joining process.

In the patent literature, arc interval welding is treated as an important variant of interval joining. Specifically, DE 2214192 A1 describes an interval welding in which interruptions in the welding phases are provided in order to achieve cooling of the welded workpiece. In EP 3 744 460 A1, on the other hand, the duration of so-called “Arc ON” phases and “Arc OFF” phases is varied in order to impose a specified shape on a generated weld seam. EP 2 810 732 A2 further teaches to record the time from the start of a short circuit until the first ignition of an arc, and then to start an arc re-ignition after a defined reference time.

For arc interval joining in general, but of course also for the aforementioned approaches from the prior art, it applies that both the duration of arc phases (hereinafter “arc duration”) and the duration of pause phases (hereinafter “pause duration”) depend on two types of points in time. On the one hand, the points in time at which an arc is extinguished (hereinafter referred to as “extinction moments”) are important; while on the other hand, the points in time at which the arc is reignited (hereinafter referred to as “ignition moments”) play a decisive role. For the pause phases mentioned, an arc is extinguished at the beginning of a pause phase at an extinction moment and is reignited at the end of a pause phase at an ignition moment. The pause duration of the corresponding pause phase is thus determined from the time period between an extinction moment and an ignition moment immediately following this extinction moment. Conversely, the time period between an ignition moment and an extinction moment immediately following this ignition moment defines the arc duration of a corresponding arc phase. Durations of arc and pause phases are typically in the range of 300 milliseconds to 500 milliseconds. Arc durations and pause durations can therefore have values of 250 milliseconds or 300 milliseconds or 350 milliseconds or 400 milliseconds or 450 milliseconds or 500 milliseconds. Depending on the application, longer or shorter arc phases and/or pause phases may also occur (e.g. even shorter than 100 milliseconds).

In order to be able to determine the durations of arc phases as well as the durations of pause phases, it is necessary to determine the extinguishing and ignition moments that occur during an arc interval joining process. In this context, it was recognized that the determination of extinction moments is a problem that is usually easy to solve in practice. Since maintaining an arc requires a voltage supply to the joining electrodes used for the welding or brazing, an arc can be extinguished simply by interrupting this voltage supply and/or by a short circuit, which is possible with high temporal precision and requires only minimal technical effort.

In contrast, determining ignition moments often proves to be complex and, depending on the situation, associated with various difficulties. In gas metal arc welding, such as MIG welding or MAG welding, but also in MIG brazing or MAG brazing, the arc can be reignited by means of an electrical contact between a joining electrode that melts during welding, such as a consumable welding wire electrode, and a workpiece (short-circuit ignition). If the joining electrode touches the workpiece for re-ignition, re-ignition can be brought about either by means of a high ignition current, or the welding or joining electrode can be lifted from the workpiece during the ignition of the arc (“drawn arc”) and the arc can be “drawn up”.

The question of when an arc will actually be reignited in such a situation is influenced by a number of factors, such as the distance that the joining electrode has to travel in a pause phase until it makes contact with the workpiece again (hereinafter “creep distance”), or the so-called creep speed with which the joining electrode is moved towards the workpiece during the pause phase, or the surface condition of a workpiece to be welded, or the intensity of the welding voltage applied for re-ignition. If these factors fluctuate, the resulting ignition moments will also fluctuate as a direct consequence. The actual ignition moment may therefore deviate from a specified target ignition moment.

Even when igniting an arc without contact between a joining electrode of a welding or brazing device and a workpiece, it is often difficult to precisely determine or predict the ignition moments that ultimately occur. For contactless ignition, an ignition voltage pulse can be applied that ionizes the area between a joining electrode and a workpiece, so that the arc ignites in the ionized area between the joining electrode and the workpiece. This can lead to ignition errors, i.e., it may happen that insufficient ionization and thus no arc is formed, in which case a further ignition attempt with another ignition voltage pulse must be made after a pause. In such cases, there is a time shift and thus, as in the case of contact ignition, a fluctuation in the ignition moment.

According to the above statements, fluctuations in ignition moments can occur during arc interval joining. Fluctuations in ignition moments result in fluctuations in pause durations, wherein in practice deviations of 1 ms to 400 ms between desired and actual pause durations have been observed. This in turn means that the amount of heat introduced into a welded or brazed workpiece can fluctuate and, for example, deviate from a specified target amount of heat, which in turn results in undesirable temperature distributions. As mentioned at the outset, the temperature distributions occurring in a workpiece are directly related to various quality factors, so that undesirable temperature distributions can result in weld seam defects or brazing defects or undesirable thermal distortion or undesirable metallurgical properties. Although these interrelationships and difficulties are well known, the prior art does not offer any suitable solutions.

It is therefore an object of the present invention to regulate the heat input into a joined workpiece more precisely during arc interval joining.

This object is achieved by the features of the independent claims. Specifically, the independent claims, for an arc interval joining process mentioned above and for a welding apparatus mentioned above, provide for determining a first pause duration of a first pause phase during the arc interval joining process and, in the event that the determined first pause duration deviates from a specified target pause duration, to change at least one joining parameter of the arc interval joining process which influences the pause durations of the pause phases in order to reduce a deviation between a second pause duration of a second pause phase, which follows the first pause phase in time, and the specified target pause duration in comparison to the deviation of the first pause duration from the target pause duration.

The procedure according to the invention makes it possible to specifically adjust arc durations and pause durations to a specified, desired or required heat input that is to be introduced into a workpiece being joined during the arc interval joining process. The specified target pause duration is advantageously adapted to the heat input to be introduced and can, for example, be determined from the heat input to be introduced using a specified mathematical relationship. In this way, the joining quality achievable with an arc interval joining process can be improved noticeably.

It should be noted that the first pause phase and the second pause phase can in principle be any pause phases selected during the arc interval joining process, given that the second pause phase temporally follows the first pause phase. The first pause phase and the second pause phase are therefore by no means necessarily the absolute first and the absolute second pause phase of the arc interval joining process, but can as well be pause phases that occur later during the course of an arc interval joining process. Furthermore, the second pause phase does not necessarily have to be the pause phase that immediately follows the first pause phase. There may be one or more additional pause phases between the first and second pause phase.

Within the scope of the invention, it was recognized that the joining current occurring during the arc interval joining process is particularly suitable for identifying arc phases and pause phases, since a joining current typically flows continuously during the arc phases, even if, for example, a pulsed arc is used (for example, a joining current also flows in an arc phase, even if an arc is interrupted by a short circuit between the welding wire and the workpiece, in particular since a joining voltage is typically still present in arc phases even in the event of a short circuit). In an advantageous manner, an arc can also burn continuously during the arc phases. During the pause phases, no joining current flows and no arc burns. An arc phase can therefore be understood as a phase in which a joining current flows. By considering the joining current, arc phases and pause phases can be reliably distinguished.

It should be noted that special arc welding processes exist that are rather unusual in practice, in which welding processes the joining current can be interrupted for particularly short periods of time, even during the arc phases. These particularly short time periods are usually shorter than 10 milliseconds, or shorter than 5 milliseconds, or shorter than 0.5 milliseconds. Phases in which a joining current generally flows and which is therefore only interrupted for a very short time, i.e. shorter than 10 milliseconds, advantageously shorter than 5 milliseconds or shorter than 0.5 milliseconds, are also regarded as arc phases in the context of these explanations. A pause phase can therefore be interpreted as a phase in which no joining current flows and which is preferably longer than 10 milliseconds or longer than 20 milliseconds or longer than 50 milliseconds.

In an advantageous manner, the arc interval joining process according to the introductory statements can be an arc interval welding process or an arc interval brazing process, wherein an arc is established in the arc phases between the joining electrode and the workpiece at least temporarily, preferably continuously, wherein the joining current for joining flows from the joining electrode through the arc between the joining electrode and the workpiece.

According to the usual implementation of controls in technical systems, the determination of a first pause duration can be done continuously, which means that a first pause duration is not only determined at one point in time during the arc interval joining process, but that this happens multiple times, preferably at points in time spaced apart from one another by a specified time interval. Each pause duration determined in this way can be a starting point for changing a joining parameter in order to bring a later pause duration closer to the specified target pause duration. These relationships are, of course, well known to a specialist in the field of control engineering. In order to be able to react quickly and promptly to a deviation between a determined pause duration and a specified target pause duration in this procedure, between a determination moment at which a pause duration is determined and a control moment at which the at least one joining parameter is changed, there can be fewer than 100 pause phases or fewer than 50 pause phases or fewer than 10 pause phases PP or fewer than five pause phases or no pause phases at all.

Within the scope of the invention, it was further recognized that it is often beneficial not to directly determine or directly measure the pause durations in question, but instead to determine at least one parameter value of at least one description parameter of the arc interval joining process which describes the first pause duration, in order to determine the first pause duration, and to determine the first pause duration from this at least one determined parameter value, i.e. to carry out an indirect determination or an indirect measurement of the pause duration according to the invention. In this way, the invention can also be used in scenarios where direct measurement of pause durations is not possible, for example because only limited sensors are available.

It was also recognized that, as a description parameter for an indirect determination, a time period between an activation moment, at which during a pause phase in particular a wire feed is reactivated and/or a voltage for supplying a joining electrode is increased again, and an ignition moment immediately following the activation moment can in particular be determined as a parameter value of the description parameter, or a creep distance that a welding wire travels between such an activation moment and an ignition moment immediately following the activation moment.

As mentioned earlier, the arc interval joining process according to the invention can advantageously be a MIG welding process or a MAG welding process in which a consumable welding wire is provided as the joining electrode in the arc phases, or it can be a MIG brazing process or a MAG brazing process in which a consumable solder is provided as the joining electrode. If a consumable solder is used in a MIG or MAG brazing process, this is referred to as “melt brazing with temporarily liquid solders”, wherein molten solder forms a liquid phase and thus a molten pool. In all cases, the arc established at least temporarily between the joining electrode and the workpiece creates a molten pool on the workpiece in the region of a joining site, both during welding and brazing. Although there is a difference in the details of the formation of the respective molten pools, in welding the base material and the filler material are melted, i.e. the workpiece and the welding electrode. In brazing, only the filler material is melted, and not the workpiece. In both welding and brazing, a joining electrode is fed, and the joining electrode is melted by the energy introduced in order to create a weld seam or brazing seam and thus a molten pool. A molten pool therefore corresponds to a liquid phase of filler material and/or material in the region of the joining site.

Within the scope of the embodiment of the joining process according to the invention as a welding or brazing method, at the beginning of the pause phases both during welding and brazing the arc is extinguished and the wire feed is stopped, the wire feed is reactivated at an activation moment after a rest interval in the pause phases and a time duration between the activation moment and an ignition moment immediately following the activation moment is determined as a parameter value of the description parameter and/or a creep distance which the welding wire travels between the activation moment and an ignition moment immediately following the activation moment is determined as a parameter value of the description parameter.

As joining parameters, a wire feed speed can be used and thus changed in an advantageous manner, and/or a joining current in an arc phase, and/or an activation moment, and/or a distance between the welding wire and the workpiece at an activation moment, and/or a time period between an extinction moment and an activation moment, and/or a current-time area in an arc phase can be used.

In particular, a combination of determining a creep distance as a parameter value of the description parameter and changing a joining current in an arc phase as a joining parameter of the arc interval joining process for adjusting a pause duration to a target pause duration was recognized as advantageous, since a creep distance can often be determined precisely and without great sensor system complexity, and, for example, the level of a joining current in an arc phase can in many cases be changed easily and without great effort.

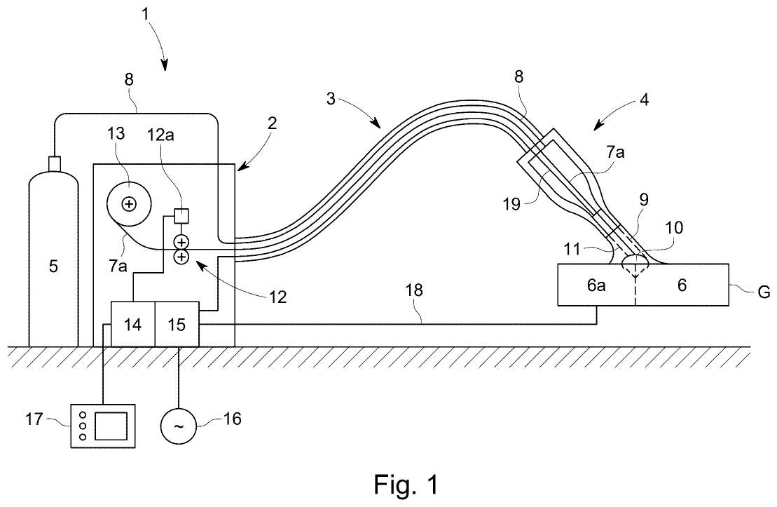

The present invention is described in greater detail below with reference to FIGS. 1 to 4b which show, by way of example, advantageous embodiments of the invention in a schematic and non-limiting manner. In the figures:

FIG. 1 is a standardized design of a welding device,

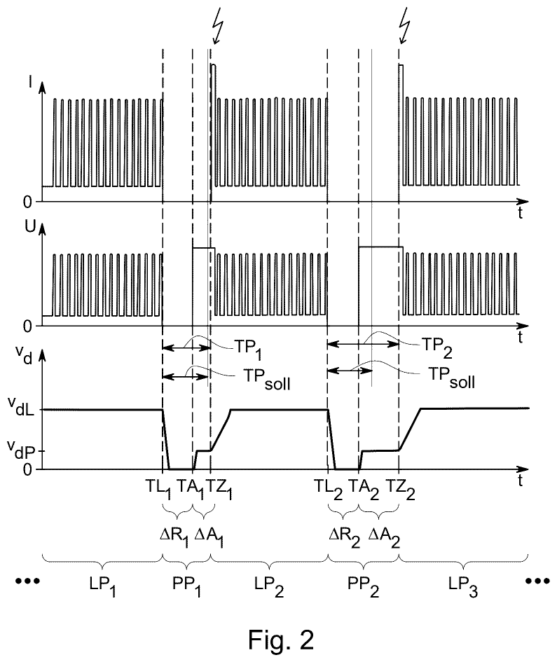

FIG. 2 is a schematic sequence of an arc interval joining process according to the prior art,

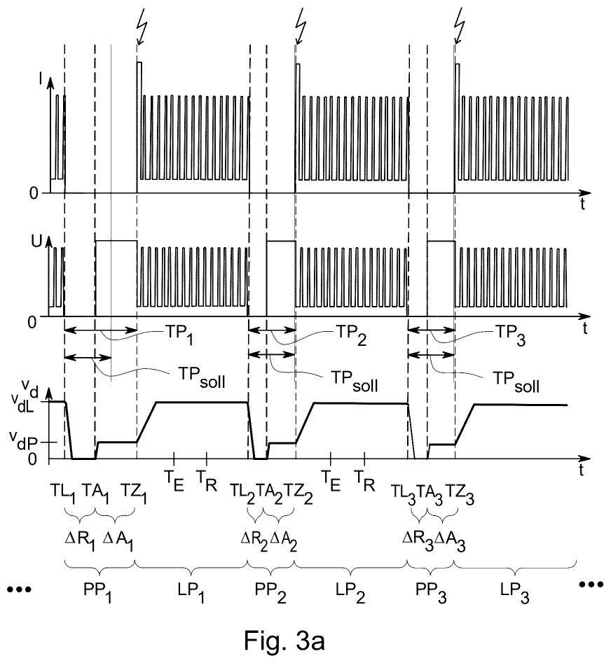

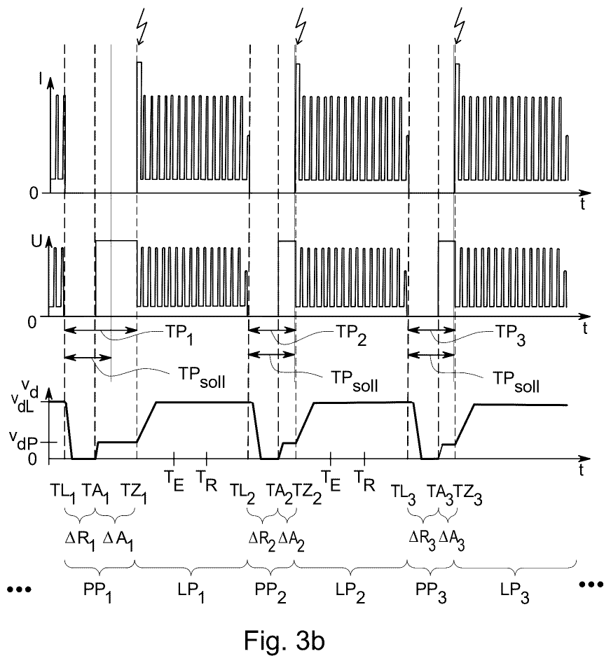

FIG. 3a is a schematic sequence of an arc interval joining process according to the invention,

FIG. 3b is an inventive arc interval joining process comprising a modification of the joining current and the wire feed speed,

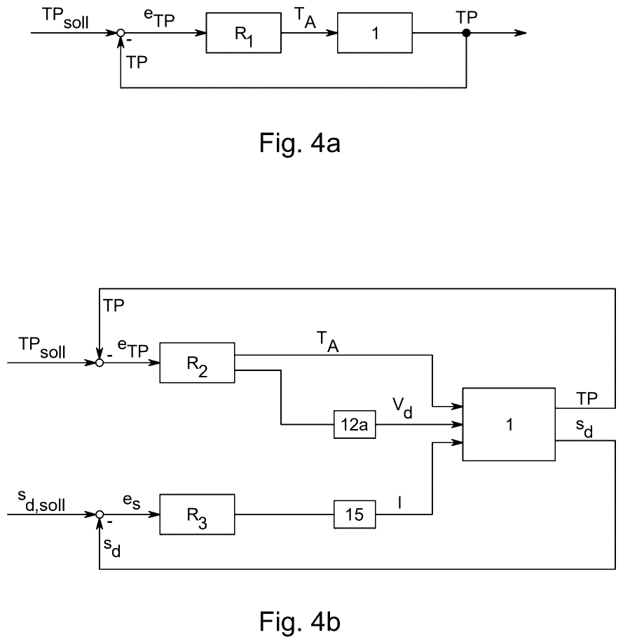

FIG. 4a, FIG. 4b each are a coupling plan for implementing the joining process according to the invention.

The present invention is explained in more detail below using a MSG welding apparatus 1 for metal inert gas welding (MSG welding), which includes in particular the known methods of metal inert gas welding (MIG welding) and metal active gas welding (MAG welding). It should be noted, however, that the invention is by no means limited to the field of metal inert gas welding and can also be used in the field of tungsten inert gas welding (TIG welding) or any other welding technique.

The MSG welding apparatus 1 under consideration can, as is well known, also be used for arc brazing. As will be explained in detail below, in order to carry out brazing processes on a MSG welding apparatus 1 it is only necessary to use a shielding gas SG suitable for brazing and a solder suitable for brazing as a filler material, i.e., as a consumable joining electrode 7. Otherwise, no changes are required, e.g. changes to the welding torch 4, etc., so that in particular the control of a MSG welding apparatus 1 as shown in FIG. 1 does not differ during brazing and welding. The present invention can accordingly also be used in the context of interval brazing, which is carried out on the MSG welding apparatus 1 according to FIG. 1, so that the following statements also apply, mutatis mutandis, to both welding and brazing. In order to emphasize this fact, the general terms joining current I, joining voltage U, joining electrode 7, etc. are used below, instead of the terms otherwise commonly used in welding such as welding current I, welding voltage U, welding electrode 7, welding wire 7a, etc., and instead of the terms otherwise commonly used in brazing such as brazing current I, brazing voltage U, brazing electrode 7, etc.

The MSG welding apparatus 1 comprises a current source 2, a hose assembly 3, a welding torch 4, and a shielding gas container 5 having a shielding gas SG. The shielding gas container 5 is connected to the welding torch 4 by means of a shielding gas line 8. A pressure regulator (not shown), for example in the form of a known cylinder fitting, can be provided on the shielding gas container 5 or in the shielding gas line 8—typically serving to regulate the flow of the shielding gas SG. Depending on the material of the substrate G, either low-reactive inert shielding gases SGi such as argon (Ar) or helium (He) or active shielding gases SGa such as oxygen (O) or carbon dioxide (CO2) are used. In a welding process without shielding gas, the shielding gas container 5 and the shielding gas line 8 can of course also be omitted. For MIG/MAG brazing, mixtures of argon, carbon dioxide and hydrogen are usually used as the shielding gas SG.

A joining electrode 7 in the form of a welding wire 7a can be arranged in the current source 2, which joining electrode is usually wound on a welding wire roll 13. A feed unit 12 driven by a feed drive unit 12a is arranged for unwinding the welding wire 7a and in particular for feeding the welding wire 7a to a joining site—i.e., to a welding site for welding or to a brazing site for brazing.

In order to braze using the MSG welding apparatus 1, a hard solder, such as a silver solder or a brass solder or a copper-based solder, can be used instead of a welding wire 7a, or a soft solder can be used, such as a tin solder, which can also be unwound from a welding wire reel 13. A person skilled in the art of joining technology is familiar with these situations.

The welding wire 7a on the welding wire roll 13, and also the feed unit 12, can, however, also be arranged outside the current source 2 in a unit which is separate therefrom. As is known, there are also embodiments of welding apparatuses 1 having multiple feed units 12, which bring about the required wire feed in an advantageous manner coordinated with one another. However, a feed unit 12 can also be arranged in the region of the joining electrode 7. This does not result in any restrictions on the applicability of the invention in question.

The feed drive unit 12a is actuated by a control unit 14, which in turn usually communicates with a user interface 17. Via a user interface 17, a user can specify certain joining parameters as required, such as a joining voltage U, a joining current I, a wire feed speed vd with which the welding wire 7a is fed to the joining site, etc. For example, predefined welding programs with certain preset joining parameters can also be stored in the control unit 14, which can be selected by the user via the user interface 17, or also by a higher-level control, such as a controller of a welding robot.

A power unit 15 is also arranged in the current source 2, which power unit is controlled (open-loop or closed-loop) by the control unit 14 and is connected to an external voltage supply 16. The control unit 14 can therefore be equipped to control and/or regulate the entire MSG welding apparatus 1 or certain components of the MSG welding apparatus 1, such as the feed unit 12, the control of the shielding gas feed and/or the power unit 15 and/or the movement of the welding torch 4. A control unit 14 can be implemented in the form of microprocessor-based hardware, a microcontroller, or an integrated circuit (ASIC, FPGA), and can of course also be arranged outside the current source 2.

The power unit 15 of the current source 2 supplies the welding torch 4 with the required joining current I and a joining voltage U via a current line 19 arranged in the hose assembly 3. The joining voltage U is applied to the joining electrode 7 for welding, so that the joining current I flows when an arc is established. In addition, the welding wire 7 (by means of the supply unit 12) and the shielding gas SG, and optionally also a cooling medium for cooling the welding torch 4, are usually supplied to the welding torch 4 via the hose assembly 3. Control lines can also be provided in the hose assembly. However, a plurality of individual lines for the respective media, control elements, and energies can be provided as the hose assembly 3.

In order to carry out a welding or brazing process, a first electrical potential is applied to a workpiece 6 made of a base material G by means of an electrical connection 18 and a second electrical potential is applied to the welding wire 7a as a joining electrode 7, as a result of which a joining current I flows after an arc 11 has been ignited between the welding wire 7a and the workpiece 6. Various types of arcs can be used, such as short arcs, transition arcs, spray arcs, pulsed arcs or cold metal transfer (“CMT”) arcs, which are well known to those skilled in the field of joining technology. Specifically, for welding, the welding wire 7a and a region of the base material G are fused by means of the arc 11, resulting in an integral bond between the melted welding wire 7a and the base material G. In the example shown, a weld seam 10 is welded onto the workpiece 6; this is referred to as build-up welding. However, two workpieces 6, 6a could also be connected, as shown by the dashed line; this is referred to as joining welding. The electric arc 11 is surrounded by the shielding gas SG flowing out of the welding torch 4 in the form of a shielding gas bell 9 in order to shield the molten material in the region of the weld seam 10 from the environment. It should be noted, however, that welding or brazing could in principle also be carried out without shielding gas SG. In this case, a shielding gas container 5 and a shielding gas line 8 could be dispensed with.

In a welding process with a non-consumable joining electrode, such as TIG welding, the welding wire 7a is fed into the arc and melted in the arc, with the arc established between the joining electrode and the workpiece.

The welding wire 7a, i.e., a melting joining electrode 7, is supplied to the joining site at a specific wire feed speed v_{d}, which can be dependent on multiple influencing variables. In manual welding, in which the welding torch 4 is guided by hand by a person, a constant wire feed speed v_{d} is usually selected depending on the joining current I set, for example. In automated welding processes, for example when the welding torch 4 is guided by a welding robot, the wire feed speed v_{d} can, for example, additionally be selected depending on a welding speed vₛ at which the welding torch 4 is moved relative to the workpiece 6.

The interval joining process according to the invention can be used in an advantageous manner for welding or brazing on a MSG welding apparatus 1 as shown in FIG. 1, wherein welding can be carried out automatically or manually.

In order to generate the required arc phases LP in which joining, i.e. welding or brazing, takes place, and the pause phases PP which alternate cyclically with the arc phases LP and in which no joining, i.e. no welding or brazing, takes place (see FIG. 2), it is necessary, according to the above explanations, to first extinguish an established arc 11 at the beginning of a pause phase PP and to stop the wire feed. Stopping the wire feed means that the wire feed speed v_{d} is reduced and brought to zero, for which purpose the rotational movement of the welding wire roll 13 must be braked in the welding apparatus shown in FIG. 1. Since a welding wire roll 13 has a physical inertia, a transition of a wire feed speed to the value zero does not occur instantaneously.

As mentioned earlier, the extinguishing of an arc 11 is possible in a convenient and precise manner, particularly by interrupting the joining voltage U. Stopping or reducing the speed of the wire feed is also generally problem-free, although it should be noted that the speed reduction of the wire feed can be started exactly at the beginning of the pause phases PP, or slightly before the start of a pause phase PP, or only slightly after the start of a pause phase PP. These situations will be discussed in detail further below.

Often, a welding wire 7a continues to be ignited for a short time during a so-called burn-off period even after the arc 11 has been extinguished, in particular since high heat is typically stored in the region of the end of the welding wire 7a facing the workpiece 6. This burning, in addition to any movement of the welding wire 7a by the feed unit 12, influences the remaining distance, the so-called creep distance s_{d}, between the axial end of the welding wire 7a and the workpiece 6 at the beginning of a pause phase PP, specifically the distance between the end of the welding wire 7a which faces the workpiece 6 and the workpiece 6.

As also explained earlier, reigniting an arc 11, in contrast to extinguishing it, proves to be difficult in many cases. Specifically, arc re-ignition in the event of a short-circuit ignition requires electrical contact between the welding wire 7a and the workpiece 6. Since in the pause phases PP the wire feed is initially reduced and brought to zero and the welding wire 7a is moved by the extent creep distance s_{d} away from the workpiece 6, it is necessary to first reactivate the wire feed in the pause phase PP in order to move the welding wire 7a back towards the workpiece 6. In order to enable a stable re-ignition of the arc 11, a wire feed speed v is typically used which is lower than the arc phases LP and is referred to in welding technology as creep speed._{d}.

A point in time in a pause phase PP at which the wire feed is reactivated and typically the voltage U applied to the joining electrode 7 is increased again for re-ignition is referred to in this patent application as activation moment TA. An activation moment TA divides a pause phase PP into two intervals. The interval between an extinguishing time TL at the beginning of a pause phase PP and an activation moment TA is referred to below as rest interval ΔR, the interval following the activation moment TA until the arc 11 is reignited at an ignition moment TZ is referred to as activation interval ΔA. As for extinguishing times TL, the same applies to activation moments TA: these times can be specified with high temporal precision (the activation of a power unit 15 or a feed drive unit 12a is usually subject to only negligible disturbances). Therefore, target values can also be provided for the duration of rest intervals ΔR, which can be realized in practice with less effort and high accuracy.

Based on the activation moments TA considered, it can be seen that in particular the creep distance s_{d}, which the welding wire 7a has to travel in a pause phase PP after the wire feed has been reactivated at an activation moment TA in the activation interval ΔA, represents a decisive influencing factor on the time of re-ignition, the ignition moment. An obvious reason for this is that at a constant wire feed speed v_{d}, it takes different lengths of time to cover different creep distance s_{d}.

The creep distance s_{d} to be traveled depends, among other things, on the aforementioned burn-off of the welding wire 7a after the end of an arc phase LP, i.e. on the wire length of the welding wire 7a which is still burned off due to the heat stored in the welding wire 7a. The end of the welding wire 7a facing the workpiece 6 is thus moved away from the workpiece 6 to a greater or lesser extent depending on the burn-off, which enlarges or reduces the creep distance s_{d} to be subsequently traveled. The creep distance s_{d} is therefore the distance between the end of the welding wire 7a facing the workpiece 6 and the workpiece 6 at an activation moment TA. Of course, a changing surface profile of the workpiece 6 over which the welding torch 4 moves can also affect the creep distance s_{d}. Likewise, the movement of the welding wire 7a through the feed unit 12 can influence the creep distance s_{d}.

Since the increase in the voltage U applied to the welding wire 7a typically begins immediately at the activation moment TA, and thus a high voltage U is already present at the point in time of renewed contact, the re-ignition usually takes place immediately after the point in time of renewed contact between the welding wire 7a and the workpiece 6, specifically when the welding wire 7a is lifted again and the arc 11 is drawn up. The points in time of renewed contact between a welding wire 7a and a workpiece 6 and the ignition moments TZ occurring after a pause phase are therefore very close to one another and are often considered to be identical in practice as a first approximation. Fluctuations in the points in time of renewed contact between the welding wire 7a and the workpiece 6 consequently inevitably lead to fluctuations in the ignition moments TZ at which the arc 11 is re-ignited at the end of the pause phases PP. Even with high-voltage ignition, depending on the applied (high) ignition voltage U, a breakdown and thus a re-ignition only occurs when the remaining creep distance s_{d} is below a certain lower limit. The point in time when this lower limit is undershot depends, as with short-circuit ignition, on the creep distances present at the beginning of an activation interval ΔA_{d}. So the same problem arises here.

To visualize these relationships, FIG. 2 shows schematic time profiles of the joining parameters joining current I, joining voltage U and wire feed speed v_{d} which can occur in an interval joining process according to the prior art, for example on a MSG welding apparatus 1 according to FIG. 1. It can be seen that in the arc phases LP₁, LP₂, LP₃ a pulsed joining voltage U and a pulsed joining current I can be used, but this is of course not necessary and is only an example of welding during the arc phases. The wire feed speed v_{d} has a value v_{dL} during the arc phases LP₁, LP₂, LP₃, and in initially reduced in this embodiment during the pause phases PP₁, PP₂ to the value zero. The joining voltage U and, as a consequence, the joining current I are also initially reduced to the value zero at the beginning of the pause phases PP₁, PP₂. To be able to ensure re-ignition of the arc 11 at the end of the pause phases PP₁, PP₂, the wire feed in the direction of the workpiece 6 is already carried out during the pause phases PP₁, PP₂ at an activation moment TA₁, TA₂, wherein a creep speed is initially used as a lower wire feed speed v_{dP}. In this embodiment, the voltage U is increased again at the activation moments TA₁, TA₂ in order to be able to immediately re-ignite the arc 11 upon renewed contact between the welding wire 7a and the workpiece 6.

Furthermore, it can be seen from the curves in FIG. 2 that the arc phases LP each lie between an ignition moment TZ at which the arc 11 is ignited and an extinction moment TL at which the arc 11 is extinguished, and that the pause phases PP each lie between an extinction moment TL and an ignition moment TZ. In addition, a target pause duration TP_{target} is specified, wherein it is desired that the actual durations of the pause phases PP₁, PP₂ correspond as exactly as possible to this target pause duration TP_{target}.

However, the fact that this requirement is not always met in practice can be derived in particular from the second pause phase PP₂. The duration of the second pause phase PP₂ is noticeably longer than the duration of the first pause phase PP₁, and deviates significantly from the specified target pause duration TP_{target}. In the present case, the reason is, for example, a changed (increased) burn-off of the welding wire 7a, so that a larger creep distance s_{d} must be traveled. Due to the chain of effects explained at the beginning: pause duration—amount of heat introduced—weld seam defects, such deviations are highly undesirable.

In order to at least reduce the problems described in FIG. 2, the invention provides for determining a first pause duration TP₁ of a first pause phase PP₁ during the arc interval joining process, and in the event that the determined first pause duration TP₁ deviates from a specified target pause duration TP_{target}, to changing at least one joining parameter of the arc interval joining process which influences the pause durations of the pause phases PP, in such a way that a deviation between a second pause duration TP₂ of a second pause phase PP₂ which follows the first pause phase PP₁, and a specified target pause duration TP_{target} compared to the deviation of the first pause duration TP₁ of the target pause duration TP_{target} are reduced. By changing the at least one joining parameter according to the invention, further pause durations TP₃, TP₄, etc. of subsequent pause phases PP₃, PP₄ following the second pause phase PP₂ are made to accord with the specified target pause duration TP_{target}. Ideally, the deviation between the specified target pause duration TP_{target} and the occurring pause durations TP₂, TP₃, etc. is reduced to zero.

This is shown in FIG. 3a using an embodiment of the invention, as will be explained in more detail below.

An efficient way to implement the invention is to directly measure the pause durations TP of the pause phases PP. As mentioned, the extinction moments TL are usually known, and the ignition moments TZ are also often automatically monitored in welding apparatuses 1, such as the one shown in FIG. 1, for example by monitoring the joining current I. From the time difference between an ignition moment TZ and the preceding extinction moment TL, the pause duration TP of a pause phase can be deduced.

In a welding process in which the arc 11 is extinguished at the beginning of the pause phases PP, the wire feed is reduced and the wire feed speed is consequently brought to zero, the duration of an activation interval ΔA between an activation moment TA and a subsequent ignition moment TZ can also be measured in order to determine the pause duration of a pause phase PP. As mentioned, activation moments TA can be determined with high precision, so that the duration of a rest interval ΔR is usually known. If the durations of both the rest interval ΔR and the activation interval ΔA in a pause phase PP are known, the pause duration TP of the pause phase PP can be determined by simple summation.

However, it is by no means necessary to directly measure the duration of an activation interval ΔA. Within the scope of the invention it was recognized that the creep distance s_{d} which the welding wire 7a has traveled in a past activation interval ΔA can be determined. In cases relevant to practice, this information is directly available in a control unit 14 for controlling a feed drive unit 12a. Since the wire feed speed v_{dP} used in the pause phases PP is of course known, the associated duration of an activation interval ΔA can easily be deduced from the path covered by the welding wire 7a after an activation moment TA—in the simplest case by division. In this case, the total duration of a pause phase PP is also calculated by summing the durations of the rest interval ΔR and the activation interval ΔA. However, since the welding wire does not usually move during a rest interval ΔR, the distance traveled by the welding wire 7a during the entire pause phase PP could also be determined.

Several options are available as joining parameters for influencing and correcting the pause durations TP of the pause phases PP. Specifically, within the scope of the invention, an activation moment TA can be shifted in time, e.g. closer to the previous extinction moment TL or further away from the previous extinction moment TL, such that the desired correction of the pause durations TP can be achieved.

Likewise, the wire feed speed vdP specified after an activation moment TA_{dP} can be increased or decreased to increase or decrease the duration of the activation interval ΔA and thus correct the pause durations TP.

In addition, it was recognized that the creep distance s_{d}, which is decisive for the duration of an activation interval ΔA, is influenced by the strength of the joining current I used in the previous arc phase LP. The reason for this is that a higher joining current I leads to more heat stored in the welding wire 7a, which leads to greater burn-off and thus to a larger creep distance s_{d}. At constant creep speed v_{d} but changing creep distance s_{d}, for obvious reasons, the duration of an activation interval ΔA and thus the resulting pause durations PP change immediately.

In a particularly advantageous manner, the joining parameters just mentioned can also be changed in combination to influence an ignition moment TZ.

The way in which the procedure according to the invention can affect the time profiles of joining current I, joining voltage U and wire feed speed v_{d} is shown in FIG. 3a. As in FIG. 2, in the case shown in FIG. 3a, a pulsed joining voltage U, which results in a pulsed joining current I, is used in the arc phases LP₁, LP₂, LP₃. As shown in FIG. 2, the wire feed speed v_{d} during the arc phases LP₁, LP₂, LP₃ has a value v_{dL} as in FIG. 3a, and is initially reduced to the value zero during the pause phases PP₁, PP₂. The joining voltage U and the joining current I are also initially reduced to zero at the beginning of the pause phases PP₁, PP₂, PP₃. As in the case shown in FIG. 2, the pause duration of the first pause phases PP₁ deviates noticeably from the specified target pause duration TP_{target}.

During the subsequent second pause phase PP₂, the second activation moment TA₂ is shifted forward, i.e., closer to the previous extinction moment TL₂. This results in a shortened rest interval ΔR compared to the first pause phase PP1₂ and thus a total pause duration TP that already corresponds very precisely to the target pause duration₂ of the entire pause phase PP₂. In the third pause phase PP₃, the time position of the activation moment TAs compared to the second pause phase PP₂ is maintained, so in the third pause phase PP₃ an equally long rest interval ΔR₃ is provided as in the second pause phase PP2, so that a satisfactory agreement with the specified target pause duration TP_{target} is maintained. The invention makes it possible to achieve a constant pause and arc duration after only a few interval cycles.

Generally speaking, the determination of the pause durations TP according to the invention can be implemented by determining a parameter value PW of a description parameter PT of the arc interval joining process, such as the duration of an activation interval ΔA or a creep distance s_{d}, to determine the first pause duration TP1, wherein the parameter value describes the first pause duration TP1; and from this parameter value PW, the at least one pause duration TP1 required to implement the invention is determined.

To determine the parameter value PW of the description parameter PT, various methods can be used, in particular those known from control engineering or signal processing, wherein the parameter value PW can be determined, inter alia, by means of a filter, such as in particular a Kalman filter, or by means of an observer, such as in particular a Luenberger observer, or by means of an adaptive system or by means of a neural network, from measured values of one or more joining parameters of the arc interval joining process.

As explained earlier, the joining current I flowing in the arc phases LP influences the burn-off of a welding wire 7a or a solder, and thus has a direct effect on the creep distances occurring in the pause phases PP_{d}. As is well known, the energy transported by an electric current over time is found as the current-time area covered by this time profile. If the current-time area is larger, more electrical energy and thus more heat is transferred, in the present case into a welding wire 7a or into a solder, which leads to greater burn-off. If the current-time area is smaller, there is less heat input and therefore less burn-off. In a corresponding manner, it is possible, by a suitable change of the joining current I, to reduce the heat remaining in a welding wire 7a at the end of an arc phase LP, thus reducing the burn-off and consequently the creep distance s_{d} to be traveled.

In addition to the joining current I, as mentioned, the wire feed speed v_{d} has an influence on the creep distance s_{d} to be traveled starting from an activation moment TA, such that in a particularly advantageous embodiment the joining current I and the wire feed speed v_{d} can be changed in combination to change the creep distance s_{d} and thus ultimately to regulate the pause durations TP of the respective pause phases PP.

It is to be noted, however, that a change in the joining current I can of course also be achieved alone, without additional change in the wire feed speed v_{d}, and that a change in the wire feed speed v_{d} of course can also be carried out alone, independently of a change in the joining current I.

The effect of a change in the joining current I within the scope of this invention is shown in FIG. 3b. In the curves shown in FIG. 3b, after the first arc phase LP₁ the amplitude of the last joining current pulse is reduced, which leads to a reduction in the transferred heat and thus to a reduction in the burn-off that occurs. In order to combine the change in the joining current I with a change in the wire feed speed v_{d}, in the situation shown in FIG. 3b, a so-called “lag” of the wire feed speed v_{d} is provided. This means that the reduction of the wire feed speed v_{d} is not immediately begun at the extinction moment TL₂, TL₃; rather, it is begun just slightly after the start of the subsequent pause phases PP₂, PP₃.

In welding or brazing processes without joining current pulses, a current-time area can be advantageously specified directly, for example an entire current-time area swept covered in an arc phase LP, or a current-time area covered in the second half of an arc phase LP. By means of the described change in the joining current I, it is possible to implement a so-called “burn-off program” and thus to achieve a specified melting rate of a welding wire 7a or a solder. In general, various attributes of a joining current I can be changed to control the burn-off, such as a peak value of the joining current I or an effective value of the joining current I or the frequency of pulses of a joining current I, or other attributes of a joining current I.

In contrast to the situation shown in FIG. 3b, the amplitude of the last joining current pulse I can also be increased in order to increase the remaining heat in the welding wire 7a and thus cause more burn-off. Also, the change in the amplitude of joining current pulses is by no means limited to the last joining current pulse, such that the amplitudes of multiple current pulses located at the end of an arc phase LP can be increased or reduced in the same way—e.g. the amplitudes of the last two joining current pulses or the amplitudes of the last three joining current pulses. In addition, the point in time at which the reduction of the wire feed speed v_{d} is started can not only be postponed to a subsequent pause phase, but can also be brought forward. Within the scope of the invention, before an extinction moment TL, within an arc phase LP, a reduction in the wire feed speed v_{d} can be started, which ultimately leads to an increase in the creep distance s_{d} contributes.

Furthermore, with regard to the time shift of the beginning of the reduction of the wire feed speed v_{d}, it should be noted that such shifts are preferably chosen to be small compared to the occurring pause durations TP and arc durations TL. “Small” means that the reduction of the wire feed speed v_{d} is usually not begun any later than after a tenth or a quarter or a third of a pause phase PP has elapsed—in any case, in such a way that the wire feed speed v_{d} within a pause phase PP can be brought to zero.

If a change in the joining current I and/or a change in the wire feed speed v_{d} is used, changing the activation moment TA in the pause phases can be omitted, as shown in FIG. 3b. However, it is also possible to set the activation moments TA in addition to the joining current I and/or in addition to the wire feed speed v_{d} as another control variable.

The method steps according to the invention can of course be implemented in software, preferably in a control unit such as the control unit 14 shown in FIG. 1. When implemented in software, the processing of the process steps to be executed typically takes place at discrete times tₖ=k·Tₛ, which is the product of a given sampling time Tₛ and a discrete index k. In a time-discrete, but of course also in an analogue, implementation, it can be advantageously provided that the pause duration of the first pause phase PP₁ during the arc interval joining process is determined at a discrete determination moment T_{E} following the first pause phase PP₁, and the at least one joining parameter of the arc interval joining process is changed to influence the pause duration TP₂ of the second pause phase PP₂ in the event that the determined first pause duration TP₁ deviates from the specified target pause duration TP_{target}, at a discrete control moment T_{R} which follows the determination moment T_{E}, to change.

In order to respond quickly and promptly to a deviation between a determined pause duration and a specified target pause duration TP_{target}, it can be provided that between the determination moment T_{E} and the control moment T_{R} there are fewer than 100 pause phases PP or fewer than 50 pause phases PP or fewer than 10 pause phases PP or fewer than five pause phases PP, or no pause phases PP at all. In a particularly advantageous way, the second pause phase PP₂ can begin only after the control moment T_{R}, such that it is ensured that the adaptation of the joining parameter to be changed has already taken place before a new pause phase PP begins.

Two advantageous implementation variants of the method according to the invention in the form of coupling plans are finally shown in FIGS. 4a and 4b. FIG. 4a summarizes the basic idea of the present invention in the form of a standard control loop well known from control engineering. According to the previous explanations, the welding apparatus 1 represents the section to be controlled, from which the occurring pause durations TP of the pause phases PP are determined.

A determined pause duration TP is compared with a specified target pause duration TP_{target}, resulting in a pause duration control error e_{TP}. The pause duration control error e_{TP} is assigned to a controller R₁ as an input variable, which then determines a changed activation moment TA as a control variable. The determined activation moment TA is in turn used in the operation of the welding apparatus 1, wherein the actually occurring pause durations TP are based on the target pause duration TP_{target} when using a suitably designed controller.

The controller R1 can be a PID controller, a model predictive controller, a flatness-based controller, a backstepping controller, or a sliding-mode controller, which can of course be implemented in a discrete-time formulation in software according to the above explanations.

In a particularly advantageous embodiment of the invention, the control law for the controller R1

$$T {A}_{k + 1} = T {A}_{k} + {e}_{TP , k}$$

can be selected. As mentioned earlier, the variable k represents a time-discrete index, so that TAₖ and TAₖ₊₁ represent two consecutive activation moments. This simple control law, which corresponds to an integrator with gain factor 1/T_{S}, postpones a subsequent activation moment TAₖ₊₁ always exactly by the deviation between the pause duration and the target pause duration at the previous point in time.

For example, to average the arising control errors e_{TP,k}, the above control law can be

$$T {A}_{k + 1} = T {A}_{k} + B \cdot {e}_{TP , k}$$

supplemented with a multiplicative setting parameter B to weight the control error e_{TP,k}.

As mentioned, in addition to changing the activation moment TA, other or additional joining parameters can also be changed in order to influence the pause durations of the pause phases PP. A possibility in this regard, in which the joining current I and the wire feed speed v_{d} are also used in addition to the activation moment TA for the implementation of the invention, is shown in FIG. 4b.

Here, too, a first control loop is provided, where, as in FIG. 4a, a determined pause duration TP is compared with a specified target pause duration TP_{target}, resulting in a pause duration control error e_{TP}, and from this a changed activation moment TA is determined as the first control variable. A special feature of the controller R2 shown in FIG. 4b is that the controller R2 can act on two control variables, on the one hand on the activation moment TA, and on the other hand on the wire feed speed v used in the pause phases_{d}. As explained in detail above, the wire feed speed v_{d} used in the pause phases PP can be used to influence the duration between activation moment TA and subsequent ignition moment TZ, so that of course the wire feed speed v_{d} can be used as a control variable to change the duration of an activation interval ΔA. As described in FIG. 3b, it is also conceivable to use the wire feed speed v_{d} at the end of an arc phase LP as a control variable for changing the pause duration TP.

As explained in detail earlier, a specified target pause duration TP_{target} produces deviating pause durations TP, particularly due to changing creep distances s_{d}, so that in FIG. 4b, by means of a further controller R3, not only is the pause duration TP itself controlled, but also the creep distance s_{d} is determined, and is compared with a specified target creep distance s_{d,target}; from this, a creep distance control error eₛ is determined, and this creep distance control error eₛ is relayed to the further controller R3 for the control loop. The possibilities provided within the scope of the invention for influencing or controlling the creep distance s_{d}, for example by changing a joining current I or a wire feed speed v_{d}, were explained in detail earlier. It should be noted that the lower control loop shown in FIG. 4b can also be provided alone.

When designing a control loop according to FIG. 4b with more than one control variable, it can also be advantageous to use methods from the control engineering field of control allocation in order to coordinate all control loops appropriately and to prevent different controllers R2, R3 or different control variables TA, v_{d}, I from hindering each other.

1. An arc interval joining process comprising a sequence of arc phases and pause phases, wherein the arc phases have a specified arc duration and alternate in time with the pause phases, wherein in the arc phases a joining current flows between a joining electrode and a workpiece for joining the workpiece, and no joining current flows in the pause phases, wherein the arc interval joining process is an arc interval welding process or an arc interval brazing process, wherein in the arc phases, at least temporarily, an arc is established between the joining electrode and the workpiece, through which arc the joining current for joining flows from the joining electrode to the workpiece, wherein at the beginning of each pause phase, the arc is extinguished at an extinction moment and is reignited at the end of each pause phase at an ignition moment, and the arc is ignited at the beginning of each arc phase at an ignition moment and is extinguished at the end of each arc phase at an extinction moment, and wherein a time period between an extinction moment and an ignition moment directly following this extinction moment corresponds to a pause duration of an associated pause phase, and a time period between an ignition moment and an extinction moment directly following this ignition moment corresponds to an arc duration of an associated arc phase, wherein, during the arc interval joining process, a first pause duration of a first pause phase is determined, and wherein, in the event that the determined first pause duration deviates from a specified target pause duration, at least one joining parameter of the arc interval joining process, which influences the pause durations of the pause phases, is changed in order to reduce a deviation between a second pause duration of a second pause phase, which follows the first pause phase in time, and the specified target pause duration compared to the deviation of the first pause duration from the target pause duration.

2. (canceled)

3. The arc interval joining process according to claim 1, wherein the at least one joining parameter of the arc interval joining process influences the respective ignition moments at the end of the pause phases.

4. The arc interval joining process according to claim 1, wherein the pause duration of the first pause phase during the arc interval joining process is determined at a determination moment subsequent to the first pause phase, wherein, in the event that the determined first pause duration deviates from the specified target pause duration, the at least one joining parameter of the arc interval joining process is changed to influence the pause duration of the second pause phase at a control moment following the determination moment, and wherein, between the determination moment and the control moment, there are fewer than 100 pause phases or fewer than 50 pause phases or fewer than 10 pause phases or fewer than five pause phases or no pause phase at all.

5. The arc interval joining process according to claim 4, wherein the second pause phase begins after the control moment.

6. The arc interval joining process according to claim 1, wherein, to determine the first pause duration, at least one parameter value of at least one description parameter of the arc interval joining process which describes the first pause duration, is determined, and wherein the first pause duration is determined from the at least one determined parameter value.

7. The arc interval joining process according to claim 6, wherein the arc interval joining process is a MIG welding process or a MAG welding process in which a consumable welding wire is provided as the joining electrode in the arc phases, or a MIG brazing process or a MAG brazing process in which a consumable solder is provided as the joining electrode, wherein the arc established at least temporarily between the joining electrode and the workpiece introduces energy into the workpiece in the region of a joining site in order to produce a molten pool, wherein the joining electrode is fed into the molten pool at a wire feed speed and wherein the joining electrode is melted by the introduced energy in the region of the molten pool in order to produce a weld seam or solder seam on the workpiece, wherein the arc is extinguished at the beginning of the pause phases and the wire feed is stopped, wherein the wire feed is reactivated after a rest interval in the pause phases at an activation moment, and wherein a time period between the activation moment and an ignition moment immediately following the activation moment is determined as the parameter value of the description parameter, and/or wherein a creep distance which the welding wire travels between the activation moment and an ignition moment immediately following the activation moment is determined as the parameter value of the description parameter.

8. The arc interval joining process according to claim 7, wherein a wire feed speed, and/or a joining current in an arc phase, and/or an activation moment, and/or a distance between the welding wire and the workpiece at an activation moment and/or a time period between an extinction moment and an activation moment, and/or a current-time area in an arc phase is changed as the joining parameter of the arc interval joining process for influencing an ignition moment.

9. The arc interval joining process according to claim 8, wherein a wire feed speed and/or a joining current in an arc phase and/or a current-time area in an arc phase are changed in order to change a distance between the welding wire and the workpiece at an activation moment as a joining parameter of the arc interval joining process for influencing an ignition moment.

10. The arc interval joining process according to claim 6, wherein the at least one parameter value of the at least one description parameter is determined by a filter or by an observer or by an adaptive system or by a neural network from at least one measured value of one or more joining parameters of the arc interval joining process, and wherein the at least one joining parameter is set to influence the second pause phase according to a specified control law.

11. A welding apparatus for carrying out an arc interval joining process, wherein the arc interval joining process comprises a sequence of arc phases with a specified arc duration and pause phases alternating in time with the arc phases, wherein in the arc phases a joining current flows between a joining electrode and a workpiece to join the workpiece, and in the pause phases no joining current flows, wherein the arc interval joining process is an arc interval welding process or an arc interval brazing process, wherein in the arc phases an arc is established at least temporarily between the joining electrode and the workpiece, through which arc the joining current for joining flows from the joining electrode to the workpiece, wherein at the beginning of each pause phase, the arc is extinguished at an extinction moment and is reignited at the end of each pause phase at an ignition moment, and the arc is ignited at the beginning of each arc phase at an ignition moment and is extinguished at the end of each arc phase at an extinction moment, and wherein a time period between an extinction moment and an ignition moment directly following this extinction moment corresponds to a pause duration of an associated pause phase, and a time period between an ignition moment and an extinction moment directly following this ignition moment corresponds to an arc duration of an associated arc phase, comprising a welding torch to generate an arc for introducing energy at a joining site on the workpiece for generating a molten pool, comprising a feed unit for feeding the joining electrode to the molten pool, wherein the joining electrode can be melted in the region of the molten pool by the energy introduced by the welding torch in order to produce a seam on the workpiece, and comprising a control unit for controlling the welding apparatus, wherein the control unit is designed to determine a first pause duration of a first pause phase during the arc interval joining process, and, in the event that the determined first pause duration deviates from a specified target pause duration, to change at least one joining parameter of the arc interval joining process which influences the pause durations of the pause phases in order to reduce a deviation between a second pause duration of a second pause phase, which follows the first pause phase in time, and the specified target pause duration compared to the deviation of the first pause duration from the target pause duration.
